(19) United States
(12) Patent Application Publication
(10) Pub. No.: US 2007/0290785 A1
(43) Pub. Date: Dec. 20, 2007

(54) Temperature Controlling Protective Device

(75) Inventor: Shih-Chang Liao, Maioli (TW)

Correspondence Address: WPAT, PC;INTELLECTUAL PROPERTY ATTORNEYS, 2030 MAIN STREET, SUITE 1300, IRVINE, CA, 92614, US

(73) Assignee: INPAQ TECHNOLOGY CO., LTD., Miaoli (TW)

(21) Appl. No.: 11/683,598

(22) Filed: Mar. 8, 2007

(30) Foreign Application Priority Data
Jun. 16, 2006 (TW) 095210491

(51) Int. Cl. H01H 85/04

(52) U.S. Cl. 337/167

(57) ABSTRACT

A temperature controlling protective device is made of a PPTC material, comprising: a body having two ends, a top surface and a bottom surface, and two ends of the body. Two electrodes made of silver gel respectively cover the two ends of the body. Two protective layers respectively cover the top surface and the bottom surface. The protective device may prevent electronic circuits from damage due to over heating.

### FIELD OF THE INVENTION

The present invention relates to a temperature controlling protective device, especially a temperature controlling protective device made of a PPTC (Polymer Positive Temperature Coefficient) material in the form of a body wherein the body has two ends, a top surface and a bottom surface and the two ends are covered respectively by two electrodes made of silver gel.

### BACKGROUND OF THE INVENTION

As well-known to persons skilled in the art, in an electronic circuit, a common way to prevent the electronic device from damage due to over heat is to utilize a temperature sensor, such as a well-known temperature fuse. The temperature sensor is not a recoverable device and thus cannot be used to prevent transient failure. As soon as the output of the circuit is shorted or a voltage fluctuates such that the circuit malfunctions, the circuit cannot be recovered to the original state. Thus, the circuit should be replaced. Accordingly, the replacement will waste time and manpower.

To address the above issue, a thermistor of PPTC material as a temperature-detecting device is proposed. The thermistor can be restored to its normal state after the device is conducted. Therefore, the thermistor may save the cost.

However, to manufacture the prior thermistor is troublesome and costly. Moreover, the resistance of the thermistor is proportional to the time (see FIG. 1 for the relationship). Therefore, it is desired that the thermistor be improved.

### SUMMARY OF THE INVENTION

An object of the invention is to provide a temperature controlling protective device made of a PPTC (Polymer Positive Temperature Coefficient) material in the form of a body wherein the body has two ends, a top surface and a bottom surface and the two ends are covered respectively by two electrodes made of silver gel.

Another object of the present invention is to provide a temperature controlling protective device that is obtained from a plurality of unit bodies of a predetermined size. Therefore, the manufacturing process of the protective device is efficient and cost effective.

Still another object of the present invention is to provide a temperature controlling protective device that can be reused and has a low resistance. In over-heat situations, the protective device may provide a good protection of electrical circuits.

### BRIEF DESCRIPTION OF THE DRAWINGS

FIG. 1 is a chart that shows the relationship between the resistance and time of the temperature controlling protective device of the present invention.

FIG. 2 is a sectional view of the temperature controlling protective device of the present invention.

FIG. 3 is a perspective view of a master plate of the present invention.

FIG. 4 shows the protective device of the present invention in use.

FIG. 5 is a chart that shows the relationship between the resistance and temperature of the temperature controlling protective device of the present invention.

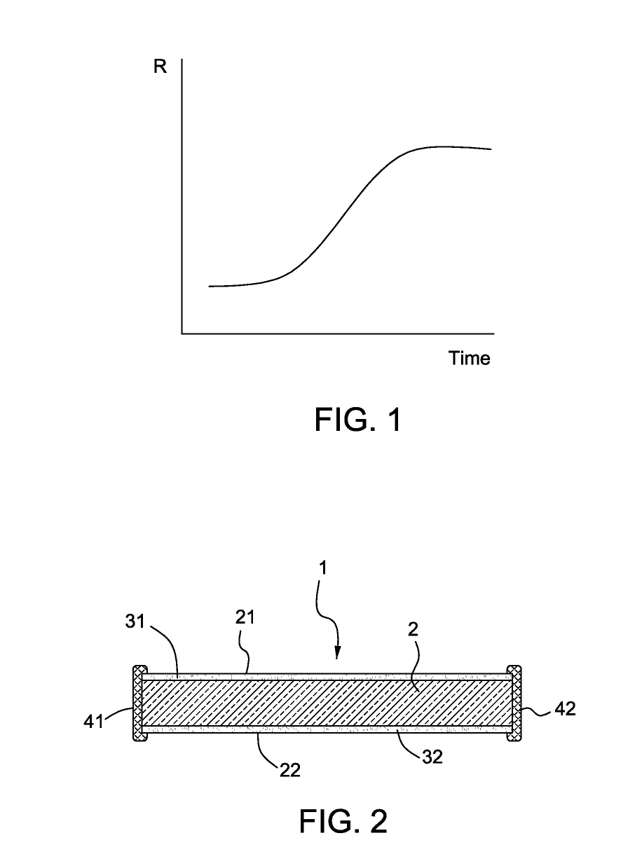

### DETAILED DESCRIPTION OF THE INVENTION

In FIG. 2, a temperature controlling protective device 1 of the present invention comprises a body 2 made of a PPTC material. The body 2 has a top surface 21 and a bottom surface 22, respectively covered by protective layers 31 and 32. The body 2 has two electrodes 41 and 42 that cover two ends 23 and 24 of the body 2 and are connected to the protective layers 31 and 32. The electrodes 41 and 42 are formed by silver gel by electrode plating process.

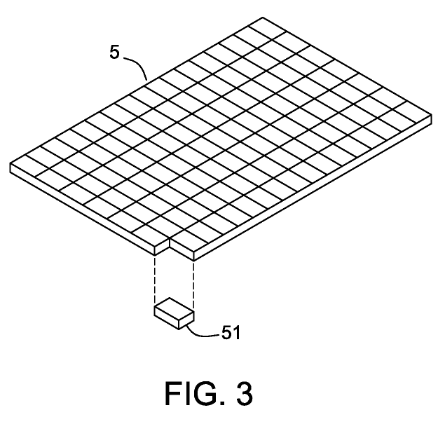

As shown in FIG. 3, before the body 2 is obtained, a PPTC material is extruded to form a master plate 5. On the master plate 5, a plurality of unit bodies 51 of a predetermined size is prepared. Then, the master plate 5 is cut to obtain the bodies 2 of the predetermined size. Afterwards, the body 2 undergoes the step of forming the protective layers 31 and 32 and the step of electrode plating the ends of the body 2 to form the electrodes 41 and 42, whereby to achieve the temperature controlling protective device 1.

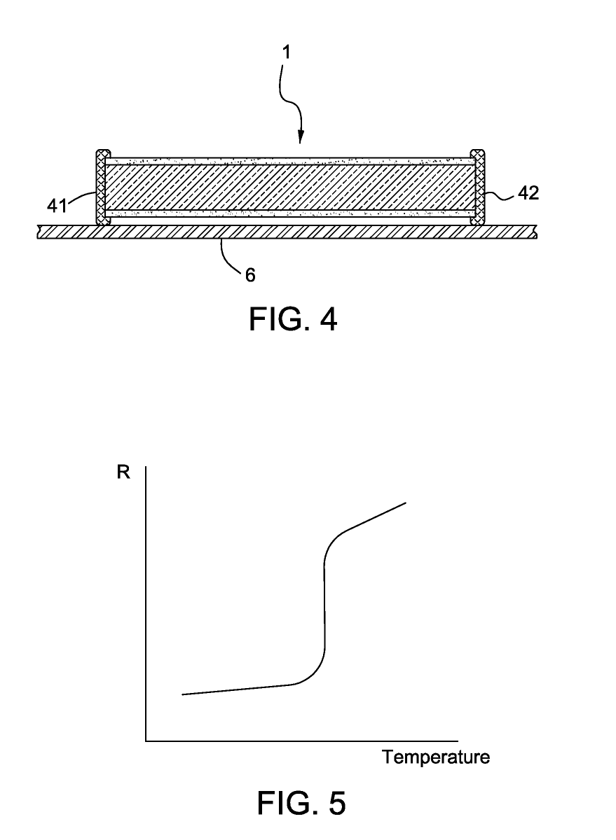

In FIG. 4, in use, the electrodes 41 and 42 of the temperature controlling protective device 1 are connected to a PC board 6. When current passes through the temperature controlling protective device 1, the resistance is proportional to the temperature (shown in FIG. 5). When the temperature exceeds the transitional point of the PPTC material, micro-crystals in the PPTC material will be melt and become non-crystals. When non-crystals prevail in the PPTC material, the resistance of the protective device 1 will increase linearly. Therefore, the protective device can achieve excellent protective effect.

The features and technical contents of the present invention have been disclosed above and those skilled in the art may make variations or modifications according to the disclosure and teachings of the present invention without departing from the spirit of the present invention. Therefore, the scope of the present invention sought to be protected should cover not only the aforementioned embodiments, but also the variations and modifications.

1. A temperature controlling protective device made of a polymer positive temperature coefficient material, comprising: a body having two ends, a top surface and a bottom surface, and two electrodes covering the two ends of the body.

2. The temperature controlling protective device according to claim 1, further comprising two protective layers respectively covering the top surface and the bottom surface.

3. The temperature controlling protective device according to claim 1, wherein the electrodes are made of silver gel.
